(19) United States
(12) Patent Application Publication
(10) Pub. No.: US 2020/0231119 A1
(43) Pub. Date: Jul. 23, 2020

(54) Anti-Theft Vehicle Shutdown Kit

(71) Applicant: Ali Mahmood, Peoria, AZ (US)

(72) Inventor: Ali Mahmood, Peoria, AZ (US)

(21) Appl. No.: 16/253,337

(22) Filed: Jan. 22, 2019

(51) Int. Cl. B60R 25/04; B60R 25/104

(52) U.S. Cl. CPC B60R 25/04; B60R 25/104; B60R 2025/1013; B60R 2025/0415; B60R 2025/0405

(57) ABSTRACT

An anti-theft vehicle shutdown kit for disabling a stolen vehicle includes a transmitter and a receiver. The transmitter comprises a transmitter circuit system coupled within a transmitter housing. The transmitter circuit system has a communication transmitter means. A power supply is coupled to the transmitter housing within the transmitter cavity and has a charging port extending through the right face. The receiver comprises a circuit system coupled within a receiver housing. A vehicle is configured to connect to an electronic system of a vehicle. The receiver circuit system has a communication receiver means and a vehicle electronics integration means. The communication receiver means receives a signal from the communication transmitter means to detect the proximity of the transmitter. The vehicle electronics integration means is configured to disable the electronic system of the vehicle to prevent it from driving when the receiver is at least a predetermined distance from the transmitter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to anti-theft devices and more particularly pertains to a new anti-theft device for disabling a stolen vehicle.

### BRIEF SUMMARY OF THE INVENTION

An embodiment of the disclosure meets the needs presented above by generally comprising a transmitter and a receiver. The transmitter comprises a transmitter housing having a front face separated from a rear face, a top face separated from a bottom face, and a left face separated from a right face. The front face, the rear face, the top face, the bottom face, the left face, and the right face form a transmitter cavity therebetween. A transmitter circuit system is coupled to the transmitter housing within the transmitter cavity. The transmitter circuit system has a communication transmitter means. A power supply is coupled to the transmitter housing within the transmitter cavity and has a charging port extending through the right face. The power supply is in operational communication with the transmitter circuit system. A power switch is coupled to the front face of the transmitter housing and is in operational communication with the power supply. The receiver comprises a receiver housing having a front panel separated from a rear panel, a top side separated from a bottom side, and a left side separated from a right side. The front panel, the rear panel, the top side, the bottom side, the left side, and the right side forming a receiver cavity therebetween. A vehicle connect cable is coupled to the receiver housing, extends through the rear panel, and is configured to connect to an electronic system of a vehicle. A receiver circuit system is coupled to the receiver housing within the receiver cavity and is in operational communication with the vehicle connect cable. The receiver circuit system has a communication receiver means and a vehicle electronics integration means. The communication receiver means receives a signal from the communication transmitter means to detect the proximity of the transmitter. The vehicle electronics integration means is configured to disable the electronic system of the vehicle to prevent it from driving when the receiver is at least a predetermined distance from the transmitter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an anti-theft vehicle shutdown kit according to an embodiment of the disclosure.

FIG. 2a is a schematic view of an embodiment of the disclosure.

FIG. 2b is a second schematic view of an embodiment of the disclosure.

FIG. 3 is a third schematic view of an embodiment of the disclosure.

### DETAILED DESCRIPTION OF THE INVENTION

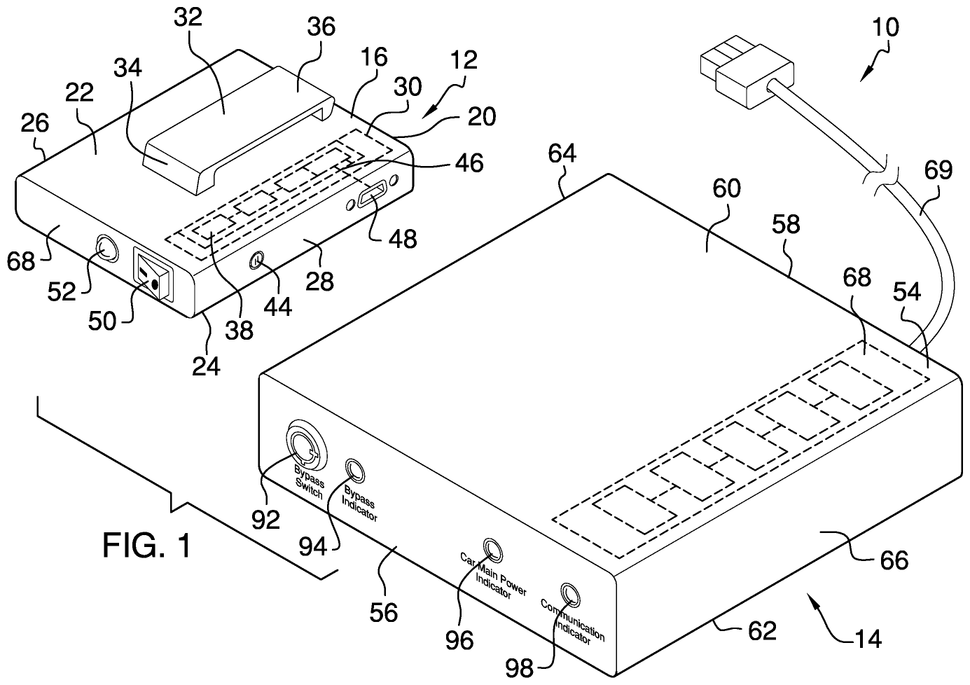

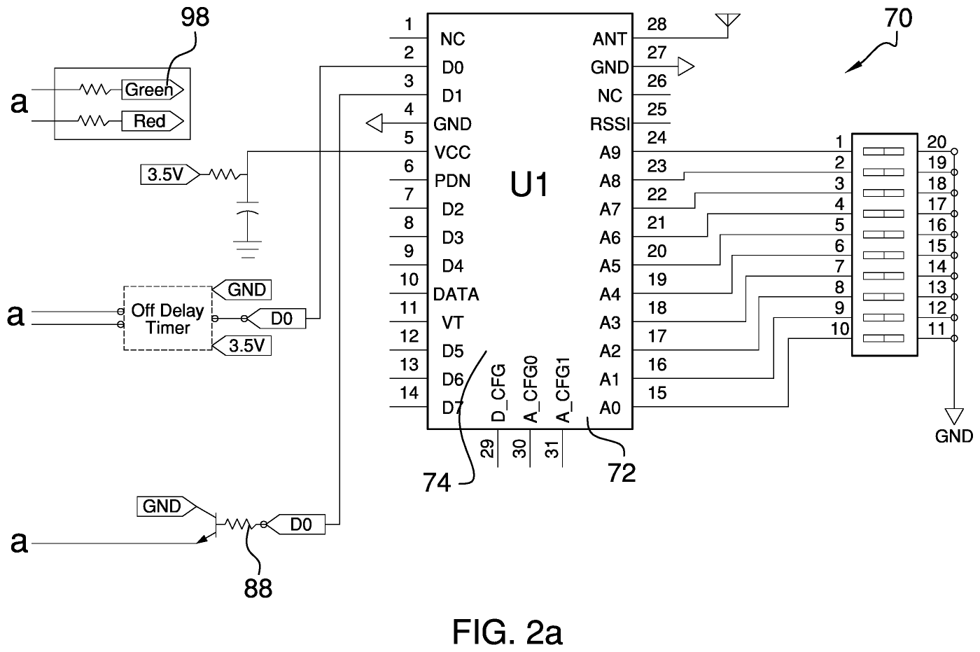

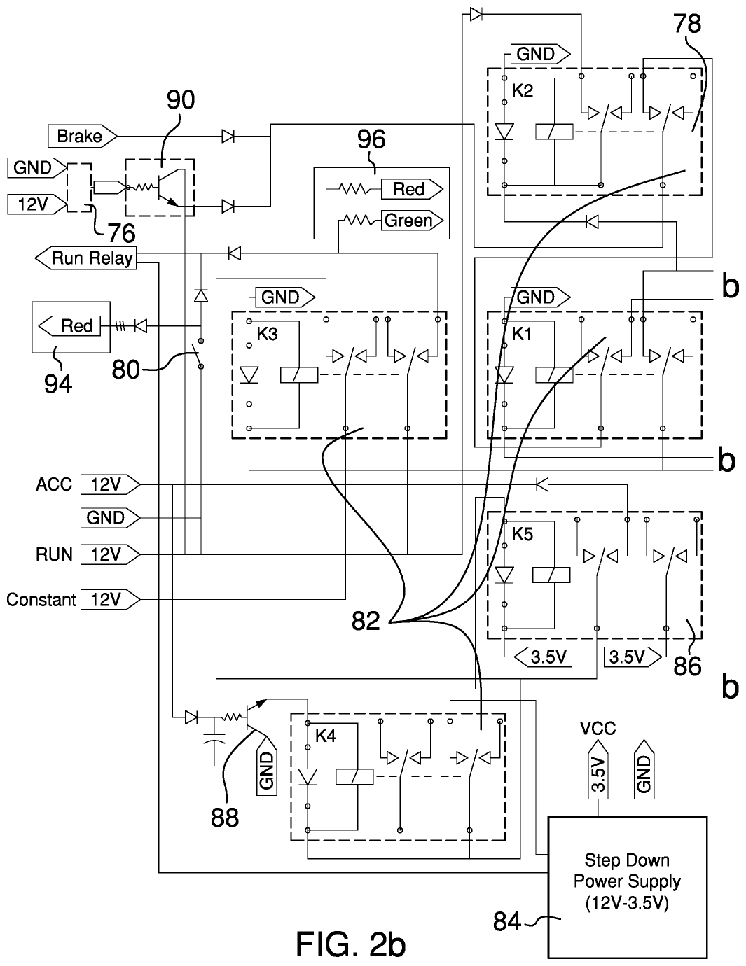

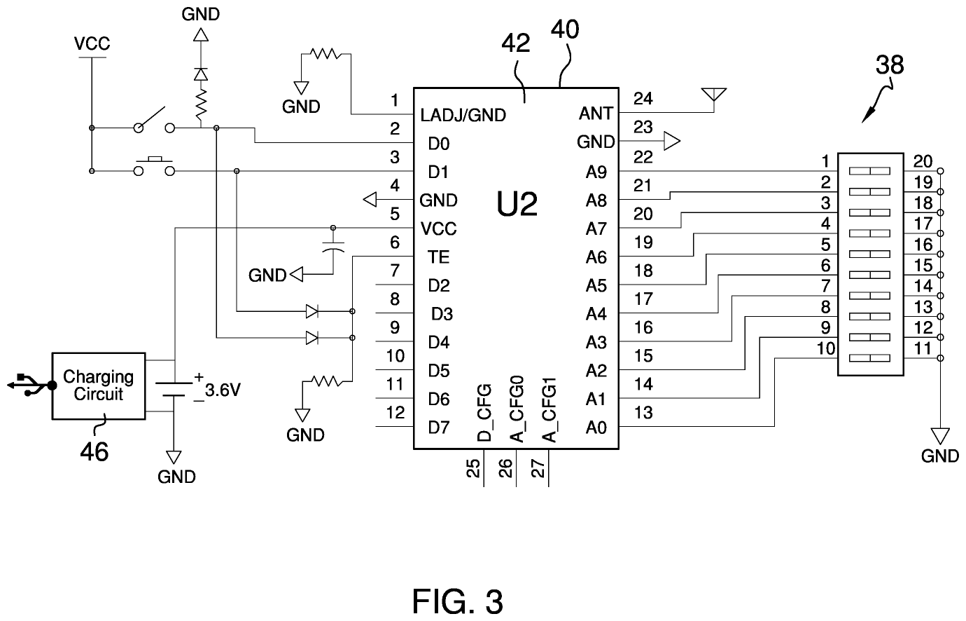

With reference now to the drawings, and in particular to FIGS. 1 through 3 thereof, a new anti-theft device embodying the principles and concepts of an embodiment of the disclosure and generally designated by the reference numeral 10 will be described.

As best illustrated in FIGS. 1 through 3, the anti-theft vehicle shutdown kit 10 generally comprises a transmitter 12 and a receiver 14. The transmitter 12 comprises a transmitter housing 16 having a front face 18 separated from a rear face 20, a top face 22 separated from a bottom face 24, and a left face 26 separated from a right face 28. The front face 18, the rear face 20, the top face 22, the bottom face 24, the left face 26, and the right face 28 form a transmitter cavity 30 therebetween. A clip 32 may be coupled to the transmitter housing 16. The clip 32 has a fixed end 34 coupled to the rear face 20 and a free end 36 and is configured to selectively engage with a user's belt. The clip 32 aids a user in keeping the transmitter with her when she exits a vehicle. A transmitter circuit system 38 is coupled within the transmitter cavity 30. The transmitter circuit system 38 has a communication transmitter means 40 that may comprise a 418 Mhz transmitter 42. A reset button 44 is coupled to the transmitter housing 16 through the right face 28 and is in operational communication with the transmitter means 40. A power supply 46 is coupled within the transmitter cavity 30 and has a charging port 48 extending through the right face 28. The power supply 46 is in operational communication with the transmitter circuit system 38. A power switch 50 is coupled to the front face 18 of the transmitter housing and in operational communication with the power supply 46. A power indicator light 52 may be coupled to the transmitter housing 16. The power indicator light 52 extends through the front face 18 and is in operational communication with the power switch 50. The power indicator light 52 illuminates when the transmitter 12 is active.

The receiver 14 comprises a receiver housing 54 having a front panel 56 separated from a rear panel 58, a top side 60 separated from a bottom side 62, and a left side 64 separated from a right side 66. The front panel 56, the rear panel 58, the top side 60, the bottom side 62, the left side 64, and the right side 66 form a receiver cavity 68 therebetween. A vehicle connect cable 69 extends through the rear panel 58 of the receiver housing and is configured to connect to an electronic system of a vehicle, including the ignition switch, fuel pump, spark plugs, and fuel injectors. A receiver circuit system 70 is coupled within the receiver cavity 68 and is in operational communication with the vehicle connect cable 69. The receiver circuit system 70 has a communication receiver means 72 that may comprise a 418 Mhz encoder 74. The receiver circuit system 70 also has a vehicle electronics integration means 76 and may have a brake detection means 78, a bypass means 80, and a reset means. The communication receiver means 72 receives a signal from the communication transmitter means 40 to detect the proximity of the transmitter 12. The vehicle electronics integration means 76 is configured to disable the electronic system of the vehicle to prevent it from driving when the receiver 14 is at least a predetermined distance from the transmitter 12. The predetermined distance may be between 15-30 meters. The brake detection means 78 is in operational communication with the vehicle electronics integration means 76 and is configured to detect when a brake of the vehicle is depressed and cause the vehicle electronics integration means 76 to only disable the electronics system of the vehicle when the brake is depressed. As such the user may leave the vehicle running when she exits with the transmitter 12, but if someone enters the vehicle and depresses the brake to try to put the vehicle in gear the vehicle will be disabled. The reset means is in operational communication with the vehicle electronics integration means 76. The reset button 44 activates the reset means of the receiver circuit system to reenable the electronics system of the vehicle after it has been disabled by the vehicle electronics integration means 76. The bypass means 80 disables the vehicle electronics integration means 76 when activated. The receiver circuit system 70 may have a plurality of 12V relays 82, a 12V-3.5V step-down power supply 84, a 3.5V relay 86, a pair of NPN transistors 88, and a PNP transistor 90. A bypass switch 92 may be coupled to the receiver housing 54 and extends through the front panel 56 and is in operational communication with the receiver circuit system 70. The bypass switch 92 activates and alternatively deactivates the bypass means 80. There may be a bypass indicator light 94 coupled to the receiver housing 54 and extending through the front panel 56. The bypass indicator light 94 is in operational communication with the bypass switch 92 and illuminates when the bypass means 80 is activated. A car power indicator light 96 may be coupled to the receiver housing 54 and extends through the front panel 56. The car power indicator light 96 is in operational communication with the vehicle electronics integration means 76 and illuminates green when the electronics system of the vehicle is active and red when the electronics system of the vehicle is inactive. A communication indicator light 98 may be coupled to the receiver housing 54 and extends through the front panel 56. The communication indicator light 98 is in operational communication with the communication receiver means 72 and illuminates green when the transmitter 12 is within the predetermined distance of the receiver 14 and illuminates red when the transmitter 12 is beyond the predetermined distance or is powered off.

In use, the receiver 14 is linked to the vehicle with the vehicle connect cable 70. The user keeps the transmitter 12 on her person and activates it using the power switch 50. If the user then leaves the vehicle or it is stolen from her, the vehicle electronics integration means 76 will disable the electronics system of the vehicle to prevent it from driving once the receiver 14 moves beyond the predetermined distance. In order for the vehicle to be operable again, the user presses the reset button 44 on the transmitter to activate the reset means of the receiver.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An anti-theft vehicle shutdown kit, the kit comprising:
a transmitter comprising:
a transmitter housing having a front face separated from a rear face, a top face separated from a bottom face, and a left face separated from a right face, the front face, the rear face, the top face, the bottom face, the left face, and the right face forming a transmitter cavity therebetween;
a transmitter circuit system coupled to the transmitter housing, the transmitter circuit system being coupled within the transmitter cavity, the transmitter circuit system having a communication transmitter means;
a power supply coupled to the transmitter housing, the power supply coupled within the transmitter cavity and having a charging port extending through the right face, the power supply being in operational communication with the transmitter circuit system; and
a power switch coupled to the transmitter housing, the power switch being coupled to the front face and in operational communication with the power supply; and
a receiver comprising:
a receiver housing having a front panel separated from a rear panel, a top side separated from a bottom side, and a left side separated from a right side, the front panel, the rear panel, the top side, the bottom side, the left side, and the right side forming a receiver cavity therebetween;
a vehicle connect cable coupled to the receiver housing, the vehicle connect cable extending through the rear panel and being configured to connect to an electronic system of a vehicle; and
a receiver circuit system coupled to the receiver housing, the receiver circuit system being coupled within the receiver cavity and in operational communication with the vehicle connect cable, the receiver circuit system having a communication receiver means and a vehicle electronics integration means, the communication receiver means receiving a signal from the communication transmitter means to detect the proximity of the transmitter, the vehicle electronics integration means being configured to disable the electronic system of the vehicle to prevent it from driving when the receiver is at least a predetermined distance from the transmitter.

2. The anti-theft vehicle shutdown kit of claim 1 further comprising the receiver circuit system having a brake detection means, the brake detection means being in operational communication with the vehicle electronics integration means, the brake detection means being configured to detect when a brake of the vehicle is depressed, the vehicle electronics integration means only disabling the electronics system of the vehicle when the brake is depressed.

3. The anti-theft vehicle shutdown kit of claim 1 further comprising the receiver circuit system having a bypass means, the bypass means disabling the vehicle electronics integration means when activated, a bypass switch being coupled to the receiver housing extending through the front panel and being in operational communication with the receiver circuit system, the bypass switch activating and alternatively deactivating the bypass means.

4. The anti-theft vehicle shutdown kit of claim 3 further comprising the receiver circuit system having a reset means and the transmitter having a reset button, the reset means being in operational communication with the vehicle electronics integration means, the reset button being coupled through the right face and being in operational communication with the transmitter means, the reset button activating the reset means of the receiver circuit system to reenable the electronics system of the vehicle.

5. The anti-theft vehicle shutdown kit of claim 4 further comprising a bypass indicator light coupled to the receiver housing extending through the front panel and being in operational communication with the bypass switch, the bypass indicator light illuminating when the bypass means is activated.

6. The anti-theft vehicle shutdown kit of claim 5 further comprising a car power indicator light and a communication indicator light coupled to the receiver housing extending through the front panel, the car power indicator light being in operational communication with the vehicle electronics integration means and illuminating green when the electronics system of the vehicle is active and red when the electronics system of the vehicle is inactive, the communication indicator light being in operational communication with the communication receiver means and illuminating green when the transmitter is within the predetermined distance of the receiver and illuminating red when the transmitter is beyond the predetermined distance or is powered off.

7. The anti-theft vehicle shutdown kit of claim 6 further comprising a power indicator light coupled to the transmitter housing extending through the front face and being in operational communication with the power switch, the power indicator light illuminating when the transmitter is active.

8. The anti-theft vehicle shutdown kit of claim 4 further comprising a clip coupled to the transmitter housing, the clip having a fixed end coupled to the rear face and a free end, the clip being configured to selectively engage with a user's belt.

9. The anti-theft vehicle shutdown kit of claim 7 further comprising the communication receiver means comprising a 418 Mhz encoder and the communication transmitter means comprising a 418 Mhz transmitter.

10. The anti-theft vehicle shutdown kit of claim 9 further comprising the receiver circuit having a plurality of 12V relays, a 12V-3.5V step-down power supply, a 3.5V relay, a pair of NPN transistors, and a PNP transistor.

11. An anti-theft vehicle shutdown kit, the kit comprising:
a transmitter comprising:
a transmitter housing having a front face separated from a rear face, a top face separated from a bottom face, and a left face separated from a right face, the front face, the rear face, the top face, the bottom face, the left face, and the right face forming a transmitter cavity therebetween;
a clip coupled to the transmitter housing, the clip having a fixed end coupled to the rear face and a free end, the clip being configured to selectively engage with a user's belt;
a transmitter circuit system coupled to the transmitter housing, the transmitter circuit system being coupled within the transmitter cavity, the transmitter circuit system having a communication transmitter means;
a reset button coupled to the transmitter housing, the reset button being coupled through the right face and in operational communication with the transmitter means;
a power supply coupled to the transmitter housing, the power supply coupled within the transmitter cavity and having a charging port extending through the right face, the power supply being in operational communication with the transmitter circuit system;
a power switch coupled to the transmitter housing, the power switch being coupled to the front face and in operational communication with the power supply; and
a power indicator light coupled to the transmitter housing, the power indicator light extending through the front face and being in operational communication with the power switch, the power indicator light illuminating when the transmitter is active; and
a receiver comprising:
a receiver housing having a front panel separated from a rear panel, a top side separated from a bottom side, and a left side separated from a right side, the front panel, the rear panel, the top side, the bottom side, the left side, and the right side forming a receiver cavity therebetween;
a vehicle connect cable coupled to the receiver housing, the vehicle connect cable extending through the rear panel and being configured to connect to an electronic system of a vehicle;
a receiver circuit system coupled to the receiver housing, the receiver circuit system being coupled within the receiver cavity and in operational communication with the vehicle connect cable, the receiver circuit system having a communication receiver means, a vehicle electronics integration means, a brake detection means, a bypass means, and a reset means, the communication receiver means receiving a signal from the communication transmitter means to detect the proximity of the transmitter, the vehicle electronics integration means being configured to disable the electronic system of the vehicle to prevent it from driving when the receiver is at least a predetermined distance from the transmitter, the brake detection means being in operational communication with the vehicle electronics integration means, the brake detection means being configured to detect when a brake of the vehicle is depressed, the vehicle electronics integration means only disabling the electronics system of the vehicle when the brake is depressed, the reset means being in operational communication with the vehicle electronics integration means, the reset button activating the reset means of the receiver circuit system to reenable the electronics system of the vehicle, the bypass means disabling the vehicle electronics integration means when activated;
a bypass switch coupled to the receiver housing, the bypass switch extending through the front panel and being in operational communication with the receiver circuit system, the bypass switch activating and alternatively deactivating the bypass means;
a bypass indicator light coupled to the receiver housing extending through the front panel and being in operational communication with the bypass switch, the bypass indicator light illuminating when the bypass means is activated;
a car power indicator light coupled to the receiver housing extending through the front panel, the car power indicator light being in operational communication with the vehicle electronics integration means and illuminating green when the electronics system of the vehicle is active and red when the electronics system of the vehicle is inactive;
a communication indicator light coupled to the receiver housing extending through the front panel, the communication indicator light being in operational communication with the communication receiver means and illuminating green when the transmitter is within the predetermined distance of the receiver and illuminating red when the transmitter is beyond the predetermined distance or is powered off.

12. An anti-theft vehicle shutdown kit, the kit comprising:
a transmitter comprising:
a transmitter housing having a front face separated from a rear face, a top face separated from a bottom face, and a left face separated from a right face, the front face, the rear face, the top face, the bottom face, the left face, and the right face forming a transmitter cavity therebetween;
a clip coupled to the transmitter housing, the clip having a fixed end coupled to the rear face and a free end, the clip being configured to selectively engage with a user's belt;
a transmitter circuit system coupled to the transmitter housing, the transmitter circuit system being coupled within the transmitter cavity, the transmitter circuit system having a communication transmitter means, the communication transmitter means comprising a 418 Mhz transmitter;
a reset button coupled to the transmitter housing, the reset button being coupled through the right face and in operational communication with the transmitter means;
a power supply coupled to the transmitter housing, the power supply coupled within the transmitter cavity and having a charging port extending through the right face, the power supply being in operational communication with the transmitter circuit system;
a power switch coupled to the transmitter housing, the power switch being coupled to the front face and in operational communication with the power supply; and
a power indicator light coupled to the transmitter housing, the power indicator light extending through the front face and being in operational communication with the power switch, the power indicator light illuminating when the transmitter is active; and
a receiver comprising:
a receiver housing having a front panel separated from a rear panel, a top side separated from a bottom side, and a left side separated from a right side, the front panel, the rear panel, the top side, the bottom side, the left side, and the right side forming a receiver cavity therebetween;
a vehicle connect cable coupled to the receiver housing, the vehicle connect cable extending through the rear panel and being configured to connect to an electronic system of a vehicle;
a receiver circuit system coupled to the receiver housing, the receiver circuit system being coupled within the receiver cavity and in operational communication with the vehicle connect cable, the receiver circuit system having a communication receiver means, the communication receiver means comprising a 418 Mhz encoder, a vehicle electronics integration means, a brake detection means, a bypass means, and a reset means, the communication receiver means receiving a signal from the communication transmitter means to detect the proximity of the transmitter, the vehicle electronics integration means being configured to disable the electronic system of the vehicle to prevent it from driving when the receiver is at least a predetermined distance from the transmitter, the brake detection means being in operational communication with the vehicle electronics integration means, the brake detection means being configured to detect when a brake of the vehicle is depressed, the vehicle electronics integration means only disabling the electronics system of the vehicle when the brake is depressed, the reset means being in operational communication with the vehicle electronics integration means, the reset button activating the reset means of the receiver circuit system to reenable the electronics system of the vehicle, the bypass means disabling the vehicle electronics integration means when activated, the receiver circuit system having a plurality of 12V relays, a 12V-3.5V step-down power supply, a 3.5V relay, a pair of NPN transistors, and a PNP transistor;
a bypass switch coupled to the receiver housing, the bypass switch extending through the front panel and being in operational communication with the receiver circuit system, the bypass switch activating and alternatively deactivating the bypass means;
a bypass indicator light coupled to the receiver housing extending through the front panel and being in operational communication with the bypass switch, the bypass indicator light illuminating when the bypass means is activated;
a car power indicator light coupled to the receiver housing extending through the front panel, the car power indicator light being in operational communication with the vehicle electronics integration means and illuminating green when the electronics system of the vehicle is active and red when the electronics system of the vehicle is inactive;
a communication indicator light coupled to the receiver housing extending through the front panel, the communication indicator light being in operational communication with the communication receiver means and illuminating green when the transmitter is within the predetermined distance of the receiver and illuminating red when the transmitter is beyond the predetermined distance or is powered off.
